(19) United States
(12) Patent Application Publication
(10) Pub. No.: US 2015/0308863 A1
(43) Pub. Date: Oct. 29, 2015

(54) OPTICAL-SENSOR-EQUIPPED CUT SLEEVE FOR CONNECTOR ADAPTER

(71) Applicant: Verizon Patent and Licensing Inc., Basking Ridge, NJ (US)

(72) Inventor: David Z. Chen, Richardson, TX (US)

(73) Assignee: Verizon Patent and Licensing Inc., Basking Ridge, NJ (US)

(21) Appl. No.: 14/262,134

(22) Filed: Apr. 25, 2014

(51) Int. Cl. G01D 5/26

(52) U.S. Cl. CPC G01D 5/268

(57) ABSTRACT

A cut sleeve includes integrated sensors to detect insertion of a fiber optic connector into an adaptor for an optical patch-panel port and to detect whether optical signals are being transmitted through optical fibers in the port. The cut sleeve includes a cylinder with a discontinuity along an axial length of cylinder. The cylinder is sized to receive a first fiber ferrule and a second fiber ferrule of substantially equal diameters. The cut sleeve includes a strain sensing module and a light sensing module. The strain sensing module can detect insertion of the first or the second fiber ferrule into the cylinder. The light sensing module can detect infrared light at an interface of the first and the second fiber ferrule within the cylinder. The strain sensing module and the light sensing module may be included on one or more microchips mounted on a cylinder surface.

### BACKGROUND

Fiber optic cables are used for providing telecommunication services to business and residential locations. An Optical Distribution Network (ODN) includes the physical fiber optic cables and devices that distribute communication signals to servers and end users. To connect fiber optic cables, each cable can be terminated with a connector and the two connectors can be coupled using an adaptor. Within an ODN, an optical patch panel may be used to manage fiber optic cable connections. The optical patch panel may include multiple ports, with each port typically configured to receive an adaptor in which connectors may be joined. Network performance can be affected if a cable becomes unplugged, or is connected to the wrong port.

### BRIEF DESCRIPTION OF THE DRAWINGS

FIG. 1 is a simplified schematic illustrating concepts described herein;

FIG. 2 is a schematic isometric view of the cut sleeve of FIG. 1;

FIG. 3 is an exemplary functional block diagram of a microchip of FIG. 2;

FIG. 4A is a schematic end view of the cut sleeve of FIG. 2;

FIG. 4B is a schematic end view of the cut sleeve of FIG. 2 with an optical fiber ferrule inserted;

FIG. 5 is a schematic cross-sectional diagram of two optical fiber ferrules joined within the cut sleeve of FIG. 2;

FIG. 6 is a schematic cross-sectional diagram of two optical fiber ferrules joined within the cut sleeve of FIG. 2 during an active communication session;

FIG. 7 is a schematic side cross-sectional view of a cut sleeve according to another implementation described herein;

FIG. 8 is another schematic side cross-sectional view of a cut sleeve according to still another implementation described herein;

FIG. 9 illustrates a fiber connection tracking system configured to use ports with the cut sleeve according to an implementation described herein;

FIG. 10 is a block diagram of exemplary components of a central computing device; and

FIG. 11 is a flow chart of an exemplary process for registering optical fiber connections according to an implementation described herein.

### DETAILED DESCRIPTION OF PREFERRED EMBODIMENTS

The following detailed description refers to the accompanying drawings. The same reference numbers in different drawings may identify the same or similar elements.

An optical patch panel may include hundreds of different ports to connect optical fibers. In a data center with a large number of optical cables, finding a connection problem can be very time-consuming. Factors such as the dense spacing of ports and wide variety of connector designs makes tracking each cable connection difficult. Mapping particular cables to particular patch-panel ports can simplify management of a fiber optic network. However, simply mapping a physical fiber infrastructure does not provide evidence of real-time use of a fiber connection. It may also be desirable to know whether or not a particular connector in a patch-panel port is actively transmitting data before a technician performs a task such as, for example, removing a connector from the port. One previous way to obtain this type of information was to tap a connection. However, tapping the connection is undesirable since it inherently results in a loss of signal strength (and raises legal concerns).

Systems and methods described herein collect information from specialized cut ferrule sleeves (or simply “cut sleeves” or “ferrule sleeves”) inside an adaptor of each optical patch-panel port. Evidence of physical insertion of a ferrule into a cut sleeve may be detected. Furthermore, wasted light from losses inside the port, and particularly from within the adaptor's cut sleeve, can be used to determine if there is active signaling through the port.

Thus, systems and methods described herein use a cut sleeve with integrated sensors to detect insertion of a connector into a port (e.g., of an optical patch panel) and to detect optical signals (e.g., traffic) through connected optical fibers within the cut sleeve. The sensors may be included, for example, on a microchip, mounted to a surface of the cut sleeve in each port. In one implementation, the microchips may communicate with a central computer to track multiple fiber connections in an optical patch panel or other data center environment.

According to one implementation, a cut sleeve includes a cylinder with a discontinuity along an axial length of cylinder. The cylinder may be sized to receive a first fiber ferrule and a second fiber ferrule of substantially equal diameters. The cut sleeve may include a strain sensing module and a light sensing module. The strain sensing module and the light sensing module may be included on one or more microchips mounted on a surface of the cylinder. The strain sensing module can detect insertion of the first fiber ferrule and/or the second fiber ferrule into the cylinder. The light sensing module can detect infrared light at an interface of the first fiber ferrule and the second fiber ferrule within the cylinder.

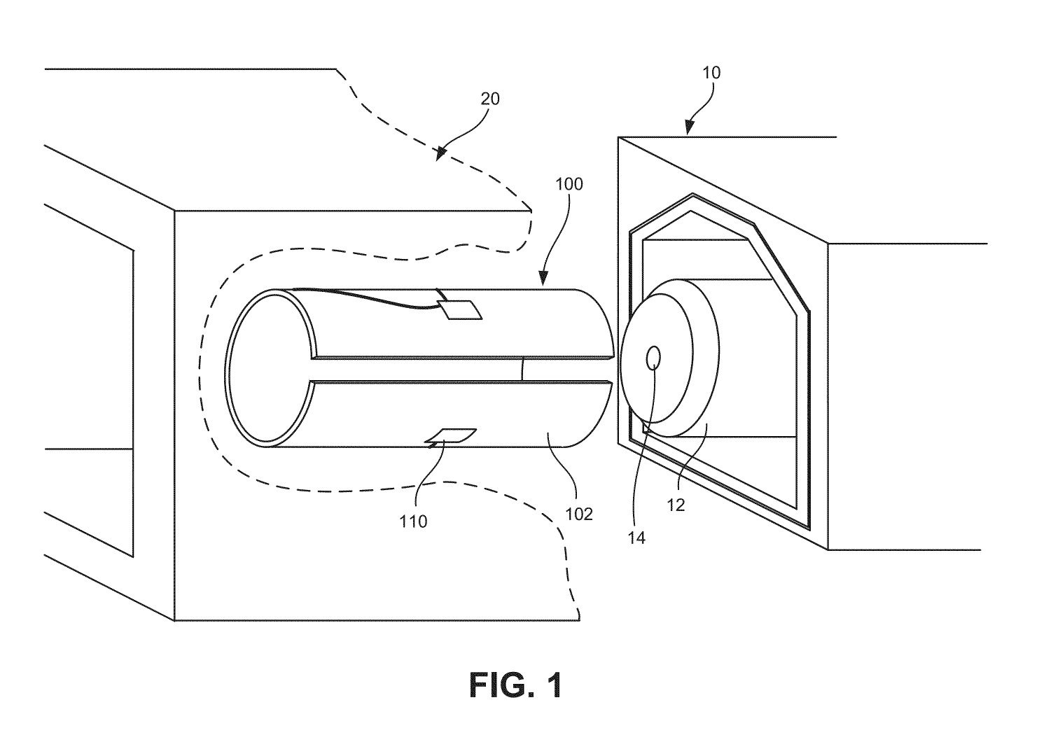

FIG. 1 is a simplified schematic illustrating concepts described herein. A fiber optic connector 10 includes a fiber ferrule 12. Fiber ferrule 12 may include a high-precision hole in the center of fiber ferrule 12 to hold a stripped, bare optical fiber 14 (e.g., a single mode or multimode optical fiber with a combination of core and cladding). Optical fiber 14 may be secured in ferrule 12 via a bonding agent, such as epoxy or adhesive. An end of optical fiber 14 is typically polished and exposed at the end of ferrule 12. The shape of the polished end of optical fiber core 14 may vary depending on the type of polish style used. Typical polished styles include Physical Contact (PC), Ultra Physical Contact (UPC), and Angled Physical Contact (APC), among others. Connector 10 may be inserted, for example, into an adaptor 20 of a patch-panel port to match the end of optical fiber 14 with another optical fiber (not shown in FIG. 1). Adaptor 20 may be mounted within a port and include, for example, a structure with clips, springs, threads, or the like, to join two connectors 10.

To facilitate proper alignment of optical fiber 14, adaptor 20 includes a cut sleeve 100 to axially center fiber ferrule 12 and the other fiber ferrule (not shown in FIG. 1) within cut sleeve 100. Cut sleeve 100 may generally include a cylinder 102 with a split (also referred to as a cut or discontinuity) along an axial length of cylinder 102. Cylinder 102 generally has an inside diameter equal to or slightly smaller than the diameter of fiber ferrule 12, such that insertion of fiber ferrule 12 causes a slight expansion of cylinder 102 and causes cylinder 102 to exert a consistent force on fiber ferrule 12 (and the other mated fiber ferrule) to maintain alignment of the optical fibers. In an exemplary configuration, cylinder 102 may be sized to receive standard diameter fiber ferrules 12, such as ferrules with a 1.25 mm outside diameter or a 2.5 mm outside diameter.

Although FIG. 1 provides a simplified view of one mechanical connector/adapter configuration, implementations described herein may apply generally to any type of fiber optic adapter that can implement a cut sleeve. For example, implementations described herein may be used in SC, LC, MU, FC-type adaptors.

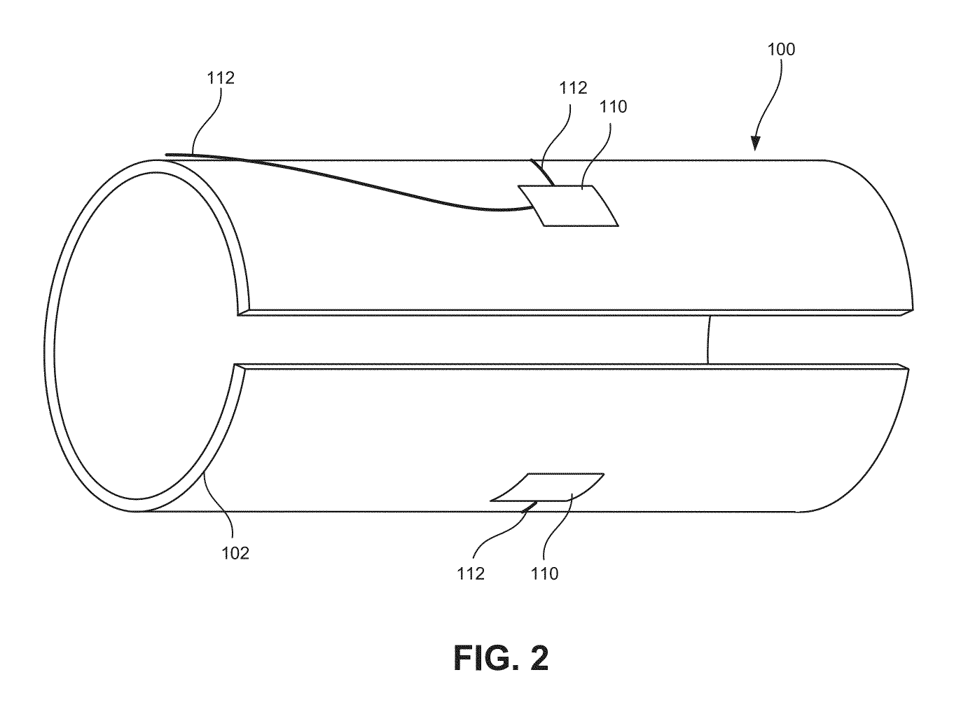

FIG. 2 is a schematic isometric view of cut sleeve 100, according to an implementation. According to an implementation described herein, cylinder 102 of cut sleeve 100 may include a material that is sensitive to infrared light. For example, silicon germanium oxide (SixGe1-xOy) may be used as a coating over a conventional ceramic sleeve material, such as zirconia (ZrO₂) or alumina (Al₂O₃). As another example, cylinder 102 may include one or more sections of a material that are sensitive to infrared light within cylinder 102.

As shown in FIG. 2, cut sleeve 100 may include one or more microchips 110 (referred to herein individually as “microchip 110” and collectively as “microchips 100”) that detect shape changes and/or property changes of cylinder 102. In one implementation, microchips 110 may be positioned in multiple locations on the outer surface of cylinder 102. As an example, microchips 110 may each have an area of about 1 square millimeter and a thickness of about 10 microns or less. Microchips 110 may be bonded to the outer surface of cylinder 102, embedded within cylinder 102, bonded to the inside surface of cylinder 102, or otherwise secured to cylinder 102. While shown in FIG. 2 as centered along a length of cut sleeve 100, in other implementations microchips 110 may be placed in different locations on cylinder 102 in a symmetrical or asymmetrical arrangement.

In one implementation, each microchip 110 may be powered by and send signals via one or more wires 112. Wires 112 may include printed wires, etchings, coated wires, or a combination of wires. Wires 112 may eventually connect to, for example, a central computer (not illustrated) that can track the status of cut sleeve 100 and its associated adaptor 20. In one implementation, cut sleeve 100 may be secured within adaptor 20 in a manner to prevent rotation of cut sleeve 100 and, thus, prevent damage to wires 112. In another implementation, a rotatable contact may be use in place of at least some wires 112 to allow connections between microchips 110 and other wires in adaptor 20 while permitting rotation of cut sleeve 100.

Each of microchips 110 on a given cut sleeve 100 may include (or be assigned) an identifier that can be used to uniquely identify the particular cut sleeve 100 and, correspondingly, the adapter or port. For example, the identifier for microchips 100 may be cross-referenced to a particular port in a network device and/or data center. In other implementations, microchip 110 may communicate via a wireless connection, such as a near-field communication (NFC) connection through a computer-controlled wireless unit.

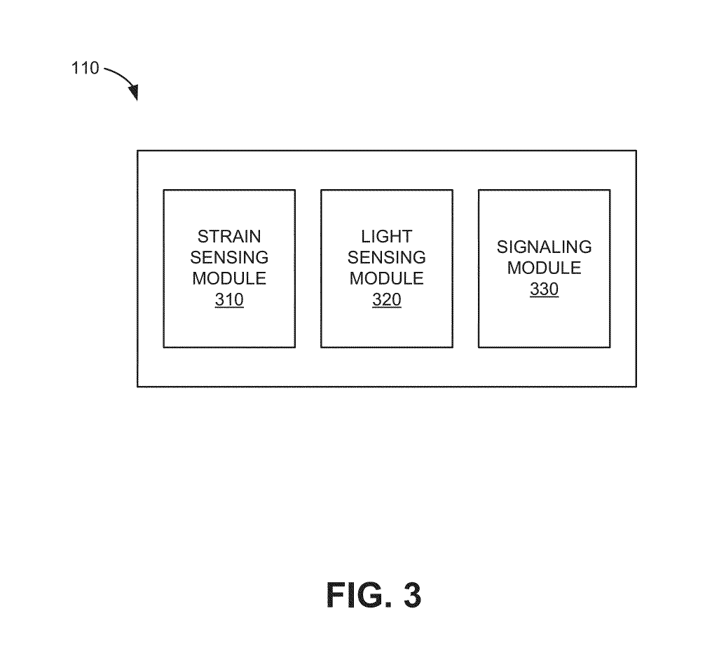

In one implementation, microchips 110 may include (or communicate with) a strain sensing module, such as a strain gauge, to detect a change in diameter of cylinder 102 as a ferrule (e.g., fiber ferrule 12) is inserted into or removed from cut sleeve 100. In another implementation, microchip 110 may include (or communicate with) a sensor to detect changes in temperature, electrical properties, or other changes associated with materials of cut sleeve 100 that are sensitive to infrared light. Microchip 110 is described further in connection with FIG. 3.

FIG. 3 is a functional block diagram of microchip 110. As show in FIG. 3, microchip 110 may include a strain sensing module 310, a light sensing module 320, and a signaling module 330. Strain sensing module 310 may include, for example, a sensor that varies its electrical resistance with applied force. In one implementation, strain sensing module 310 may include a metallic foil-type strain gauge that may be bonded to a surface of cylinder 102. The strain gauge may be connected to an electric circuit that is capable of measuring the changes in resistance corresponding to strain in cylinder 102. In another implementation, strain sensing module 310 may include a strain gauge that is insensitive to ambient temperature variations (e.g., within a range of about −40 to 60 degrees C.). In still other implementations, strain sensing module 310 may include optical strain-sensing technologies. The strain gauge of strain sensing module 310 may include metallic and/or non-metallic components.

Generally, strain sensing module 310 may detect a change in diameter of cylinder 102 as a ferrule is inserted into or removed from either end of cut sleeve 100. In one implementation, strain sensing module 310 may be calibrated to detect whether ferrules are inserted into one or both ends of cut sleeve 100. In another implementation, strain sensing module 310 may be calibrated to detect if a ferrule is fully inserted (e.g., up to a midpoint along an axial length of cut sleeve 100) or partially inserted into cut sleeve 100. According to a configuration described herein, multiple microchips 110 with strain sensing module 310 may collect different strain data from multiple points on cut sleeve 100.

Light sensing module 320 may include for example, a sensor to detect infrared leakage from connected optical fibers 14 of ferrules 12 within cut sleeve 100. More particularly, light sensing module 320 may detect connector leakage from optical signals passing through optical fibers 14. Despite attempts to optimize mechanical connections of optical fibers, mechanical connections always have insertion losses at the fiber-to-fiber interface. These losses are given off as waste light in the infrared spectrum (e.g., infrared radiation) within cut sleeve 100. Light sensing module 320 may detect the waste light to identify active signals, indicating a live connection through optical fibers 14.

In one implementation, light sensing module 320 may detect property changes associated with an infrared-sensitive material of cut sleeve 100. For example, light sensing module 320 may include a photosensitive cell to detect a color change when the infrared-sensitive material of cut sleeve 100 is exposed to waste energy (e.g., infrared light) from the fiber-to-fiber interface. In another implementation, waste energy from the fiber-to-fiber interface may be converted into electrical energy by the infrared-sensitive material and this electrical energy may be detected by light sensing module 320. Additionally, or alternatively, waste energy from the fiber-to-fiber interface may cause a temperature change in the infrared-sensitive material, which may be detected by light sensing module 320. In still another implementation, light sensing module 320 may include a light sensor to directly detect light emitted from a fiber-to-fiber connection within cut sleeve 100.

In on implementation, light sensing module 320 may detect separation between individual insertion loss instances (e.g., flickering of waste infrared light). Based on the detected rate of flickering, light sensing module 320 (or another module on microchip 110 or another device, such as a central computer) may determine an approximate data rate (e.g., 1 Mbps, 10 Mbps, 1 Gbps, 5 Gbps, etc.) for communications through the port associated with microchip 110 and/or cut sleeve 100.

Signaling module 330 may communicate changes detected by strain sensing module 310 and light sensing module 320 to an outside monitoring device, such as a central computer. In one implementation, signaling module 330 may include a unique identifier associated with microchip 110 and/or cut sleeve 100 along with status indicators from strain sensing module 310 and light sensing module 320.

The functional components of microchip 110 illustrated in FIG. 3 are for illustrative purposes only. Microchip 110 may include additional, fewer and/or different components than those depicted in FIG. 3. For example, in one implementation, one microchip 110 may include strain sensing module 310 and another microchip 110 may include light sensing module 320.

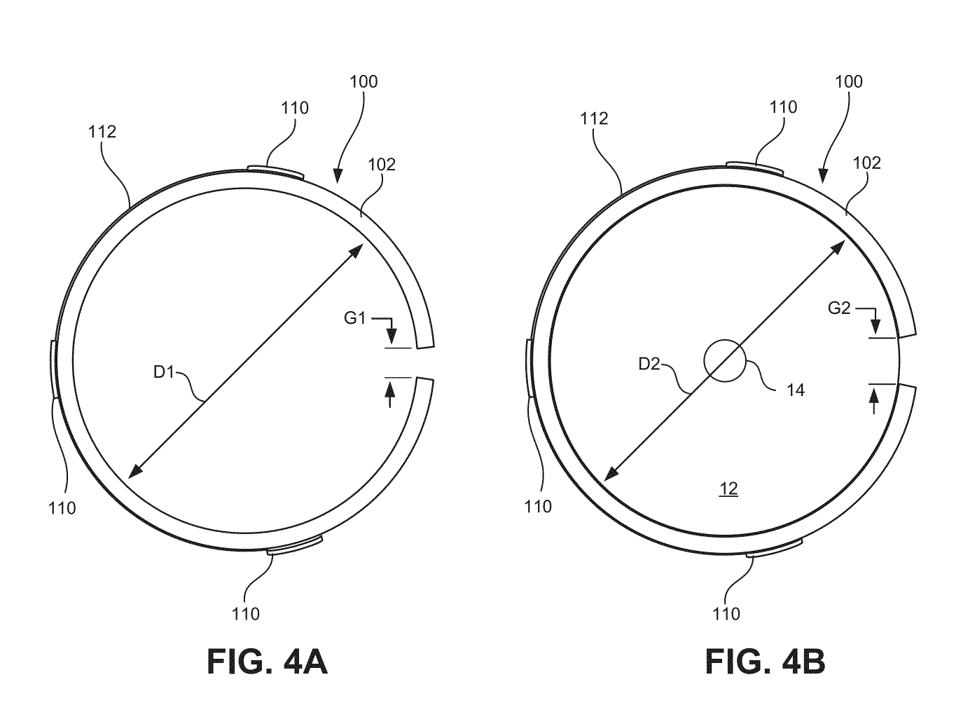

FIG. 4A is an end view of cut sleeve 100, and FIG. 4B is an end view of cut sleeve 100 with a ferrule 12 inserted therein. As shown in FIG. 4A, cylinder 102 may have an initial diameter, D1, and a small gap size, G1, along the length of the sleeve when no ferrules are inserted in cut sleeve 100. Diameter D1 may be smaller than or equal to the diameter of ferrule 12, such that insertion of ferrule 12 may cause diameter D1 and/or gap size G1 to change to allow cut sleeve 100 to accommodate ferrule 12.

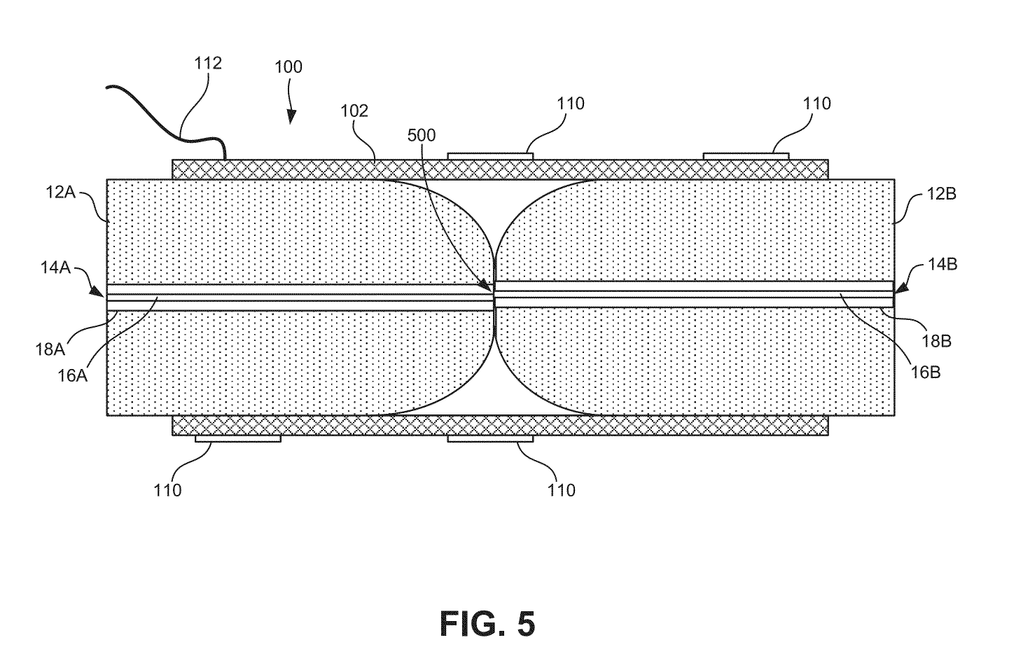

As shown in FIG. 4B, insertion of ferrule 12 may cause the diameter of cylinder 102 to increase to D2 and the gap size to expand to G2. The change of diameter from D1 to D2 (upon insertion of ferrule 12) or from D2 to D1 (upon extraction of ferrule 12) may be sensed by one or more of microchips 110. For example, strain sensing module 310 may detect an increase from diameter D1 to D2 and to indicate an insertion of ferrule 12 into cut sleeve 100. In one implementation, microchips 100 may be located near opposite ends of cut sleeve 100 (e.g., as shown in FIG. 5) to better detect insertion of a ferrule 12 into one side or the other of cut sleeve 100 and extraction of ferrule 12 from one side or the other of cut sleeve 100.

FIG. 5 is a schematic cross-sectional diagram of two optical fiber ferrules 12 joined within cut sleeve 100 when no signals are passing between a pair of optical fibers, according to an implementation described herein. As shown in FIG. 5, ferrule 12A may be mated to ferrule 12B to provide an optical connection between optical fibers 14A and 14B. Optical fibers 14A and 14B are shown with cores 16A/16B and cladding 18A/18B respectively. In the configuration of FIG. 5, cylinder 102 may include material sensitive to infrared light. Generally, cut sleeve 100 (along with other components of connector 10 and adapter 20) may provide and maintain proper geometry of the connection to provide optimal signal transfer at an interface 500 between optical fiber cores 16A and 16B. When cut sleeve 100 is not exposed to infrared light, such as waste light from connection losses at interface 500, the material of cylinder 102 may have a baseline set of material properties. These baseline material properties may include a consistent temperature and/or electrical conductivity (e.g., as measured at each of microchips 110). Conditions for these baseline material properties may exist, for example, when ferrule 12A and ferrule 12B are mated within cut sleeve 100 and no optical signals are passing between interface 500 of optical fiber cores 16A and 16B.

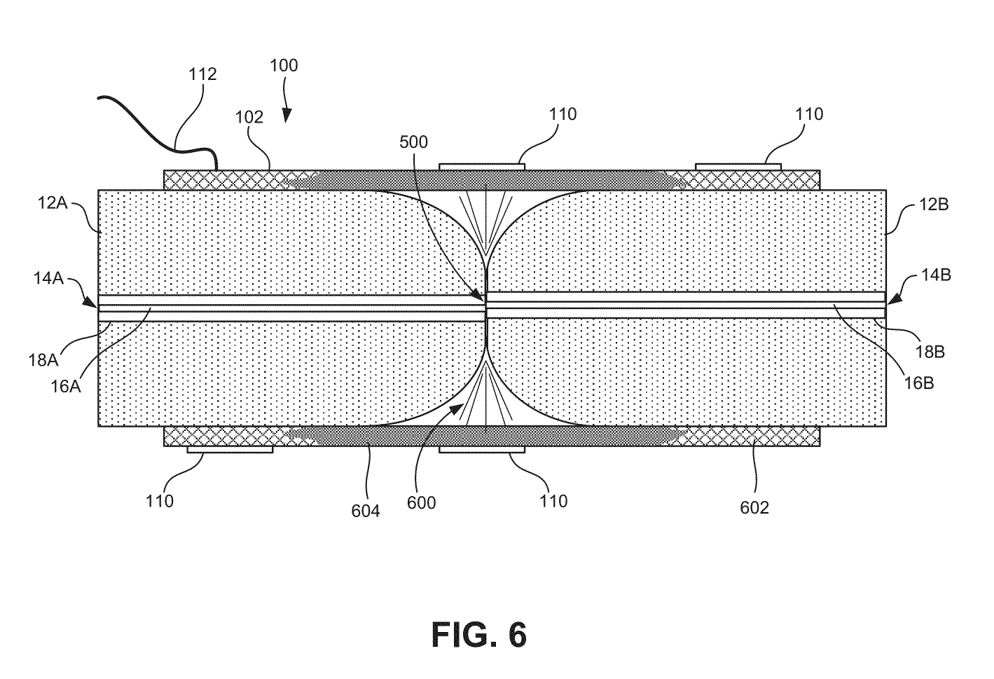

FIG. 6 is a schematic cross-sectional diagram of two optical fiber ferrules 12 joined within cut sleeve 100 when optical signals are passing between a pair of optical fibers, according to an implementation described herein. Mechanical imperfections (and/or installation errors) will virtually always result in insertion losses due to fiber separation (longitudinal misalignment), lateral misalignment, and/or angular misalignment at interface 500. Even in a good connection between optical fiber cores 16A and 16B (e.g., with losses of no more than 0.75 dB), connection losses will still produce detectable infrared light 600 when optical signals are passing between optical fiber cores 16A and 16B at interface 500. Because the material of cylinder 102 is sensitive to infrared light, when the material of cylinder 102 is exposed to infrared light 600, the material can change from a baseline state (e.g., the baseline set of material properties) indicated by reference number 602 to an altered state 604. In one implementation, as shown in FIG. 6, the state change between baseline state 602 and altered state 604 may be localized. In another implementation, infrared light 600 may provide uniform state change throughout cylinder 102. One or more microchips 110 may be positioned on cut sleeve 100 at a probable location to detect a state change when light leakage occurs at interface 500.

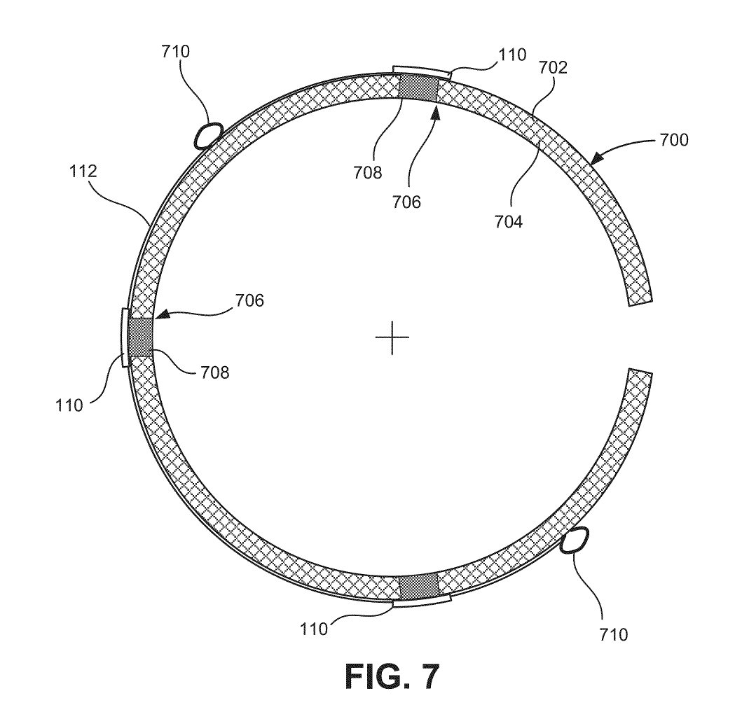

FIG. 7 is a schematic side cross-sectional view of cut sleeve 700 according to another implementation described herein. Cut sleeve 700 may be configured in a manner similar to cut sleeve 100 above, with microchips 110 included to detect changes in the sleeve diameter and/or changes in temperature, electrical properties, or other changes associated with materials that are sensitive to infrared light. As shown in FIG. 7, cut sleeve 700 may include a cylinder 702 comprising a typical structural material 704, such as a ceramic material, with a shape and diameter to geometrically align ferrules 12 (not shown in FIG. 7) within cut sleeve 700. Holes 706 in cylinder 702 may be filled with an infrared-sensitive material 708. In one implementation, holes 706 and infrared-sensitive material 708 may be located axially along cut sleeve 700 near a midpoint or another location where connection losses between optical fibers (e.g., optical fiber cores 16A and 16B at interface 500) are most likely to be detected.

In the implementation of FIG. 7, cut sleeve 700 may also include one or more contacts 710 to maintain a physical communication connection with wires in adapter 20 while permitting cut sleeve 700 to rotate. Contacts 710 may include, for example, a copper pad that maintains physical contact with a corresponding copper strip (not shown) mounted within adapter 20 and around a portion of the circumference of cut sleeve 700. In one implementation, microchips 110 may be mounted over holes 706 and infrared-sensitive material 708 (or portions thereof) on the outer surface of cylinder 702 and overlap onto structural material 704. Thus, microchips 110 may detect both strain changes in structural material 704 and infrared-sensitive material 708 along with material property changes of infrared-sensitive material 708 (e.g., when optical signals passing between optical fiber cores 16A and 16B produces infrared leakage at interface 500).

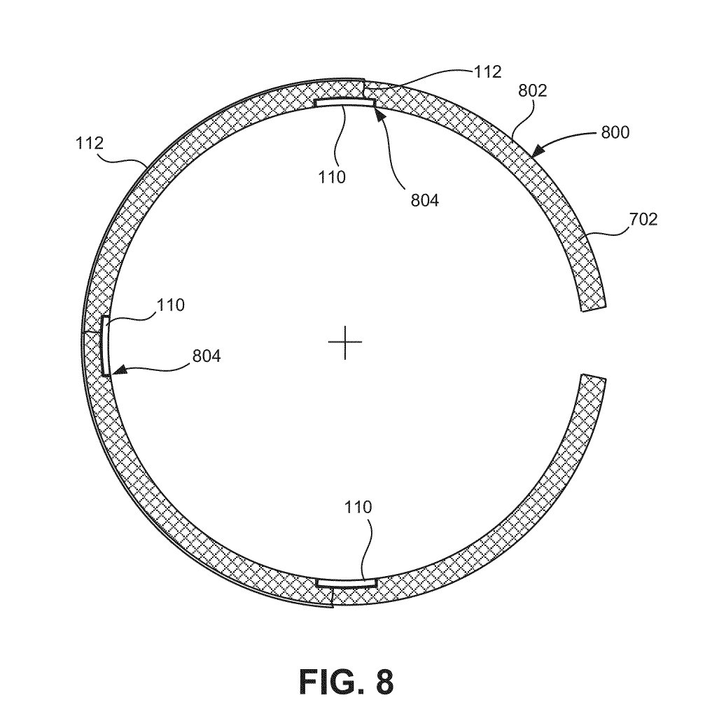

FIG. 8 is a schematic side cross-sectional view of a cut sleeve 800 according to another implementation described herein. Similar to cut sleeve 100 above, cut sleeve 800 may include microchips 110 included to detect changes in the sleeve diameter. Cut sleeve 800 may include a cylinder 802 made of structural material 702, such as a ceramic material, with a shape and diameter to geometrically align ferrules 12 (not shown in FIG. 8) within cut sleeve 800. As shown in FIG. 8, recesses 804 in cylinder 802 may be formed along an interior surface of cut sleeve 800. Each of recesses 804 may be sized to allow a microchip 110 to fit inside recess 804. Wires 112 may extend from an outer surface of cut sleeve 800 into each of recesses 804 to provide power/communication for microchips 110.

In the configuration of FIG. 8, microchips 110 may be positioned to directly sense infrared light from connection losses of optical fibers (e.g., between optical fiber cores 16A and 16B at interface 500). Thus, cut sleeve 800 may not include infrared-sensitive material. In one implementation, at least one of recesses 804 and microchips 110 may be located axially along cut sleeve 800 near a midpoint or another location where connection losses are most likely to be detected.

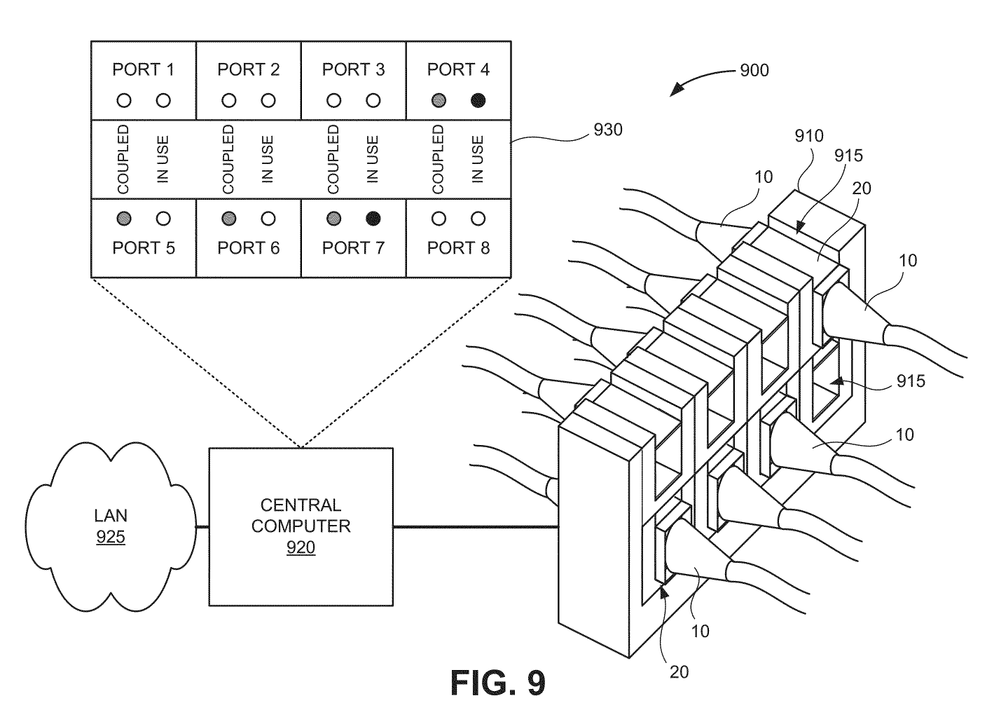

FIG. 9 illustrates a fiber connection tracking system 900 configured to use ports with cut sleeves according to an implementation described herein. As shown in FIG. 9, a patch panel 910 may include multiple ports 915. Each port may include an adaptor 20. Connectors 10 may be inserted into adapters 20 of some of the ports 915 to provide a connection of optical fiber cores 14 inside cut sleeves 100 (not visible in FIG. 9), as described above in connection with, for example, FIGS. 1-8. Each cut sleeve 100 may include one or more microchips 110, as described above.

In one implementation, a central computer 920 may track the status of each port 915 in patch panel 910 based on signals received from microchips 110 on cut sleeves 100. Central computer 920 may, for example, provide real-time data or display 930 to monitor the status of ports 915 in patch panel 910. In one implementation, the connection status for each port may be stored in a searchable database that may be accessed, for example, by other devices within a local area network (LAN) 925. Thus, the status of any particular port 915 or range of ports 915 could be identified from a device (e.g., a device with access to LAN 925 and providing appropriate credentials) using a database lookup.

LAN 925 may include, for example, a LAN, an intranet, a private wide area network (WAN), etc. In one implementation, private network 170 may implement one or more Virtual Private Networks (VPNs) for providing communication between, for example, central computer 920 and remote devices. Although shown as a single element in FIG. 9, LAN 925 may include a number of separate networks.

Insertion of a connector 10 into the adapter 20 of a port 915 may be detected by strain sensing module 310 on the cut sleeve 100 for that particular port 20. For example, as described above with respect to FIGS. 3-4B, strain sensing module 310 may detect a change (e.g., increase) in diameter when a ferrule 12 of connector 10 is inserted into cylinder 102 of cut sleeve 100. Microchip 110 may provide a signal to central computer 920 indicating, for example, the ferrule ID and that a connector is physically coupled to the port 20. As shown in FIG. 9, display 930 indicates that central computer 920 received “coupled” signals from cut sleeves 100 associated with “Port 4,” “Port 5,” “Port 6,” and “Port 7.”

When traffic passes though a set of fibers coupled in port 915, infrared light from insertion losses may be detected by light sensing module 320 on the cut sleeve 100 for that particular port 915. For example, as described above with respect to FIGS. 3, 5, and 6, light sensing module 320 may detect a property change in infrared-sensitive material of cut sleeve 100 when optical signals pass through the interface 500 between optical fiber cores 16A and 16B in port 915. Microchip 110 may provide a signal to central computer 920 indicating, for example, the ferrule ID and that a connector is currently transmitting traffic. As shown in FIG. 9, display 930 indicates that central computer 920 received “in use” signals from cut sleeves 100 associated with “Port 4” and “Port 7.”

Although FIG. 9 provides a simplified environment of a patch panel monitoring configuration, in other implementations different or additional equipment and/or displays may be used.

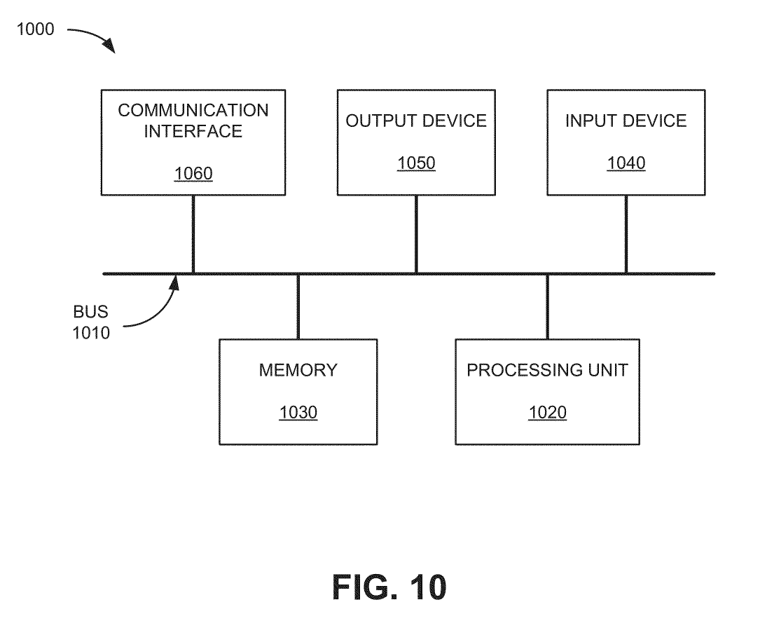

FIG. 10 is a diagram of exemplary components of central computer 920. As shown in FIG. 10, central computer 920 may include a bus 1010, a processing unit 1020, a memory 1030, an input device 1040, an output device 1050, and a communication interface 1060.

Bus 1010 may permit communication among the components of central computer 920. Processing unit 1020 may include one or more processors or microprocessors that interpret and execute instructions. In other implementations, processing unit 1020 may be implemented as or include one or more application specific integrated circuits (ASICs), field programmable gate arrays (FPGAs), or the like.

Memory 1030 may include a random access memory (RAM) or another type of dynamic storage device that stores information and instructions for execution by processing unit 1020, a read only memory (ROM) or another type of static storage device that stores static information and instructions for the processing unit 1020, and/or some other type of magnetic or optical recording medium and its corresponding drive for storing information and/or instructions.

Input device 1040 may include a device that permits an operator to input information to central computer 920, such as a keyboard, a keypad, a mouse, a pen, a microphone, one or more biometric mechanisms, and the like. Output device 1050 may include a device that outputs information to the operator, such as a display, a speaker, etc.

Communication interface 1060 may include a transceiver that enables central computer 920 to communicate with other devices and/or systems. For example, communication interface 1060 may include mechanisms for communicating with other devices, such as other computing devices. Each of such other devices may include its respective communication interface 1060 to achieve such communication.

As described herein, central computer 920 may perform certain operations in response to processing unit 1020 executing software instructions contained in a computer-readable medium, such as memory 1030. A computer-readable medium may include a tangible, non-transitory memory device. A memory device may include space within a single physical memory device or spread across multiple physical memory devices. The software instructions may be read into memory 1030 from another computer-readable medium or from another device via communication interface 1060. The software instructions contained in memory 1030 may cause processing unit 1020 to perform processes described herein. Alternatively, hardwired circuitry may be used in place of or in combination with software instructions to implement processes described herein. Thus, implementations described herein are not limited to any specific combination of hardware circuitry and software.

Although FIG. 10 shows exemplary components of central computer 920, in other implementations, central computer 920 may contain fewer, different, differently-arranged, or additional components than depicted in FIG. 10. In still other implementations, a component of central computer 920 may perform one or more other tasks described as being performed by another component of central computer 920.

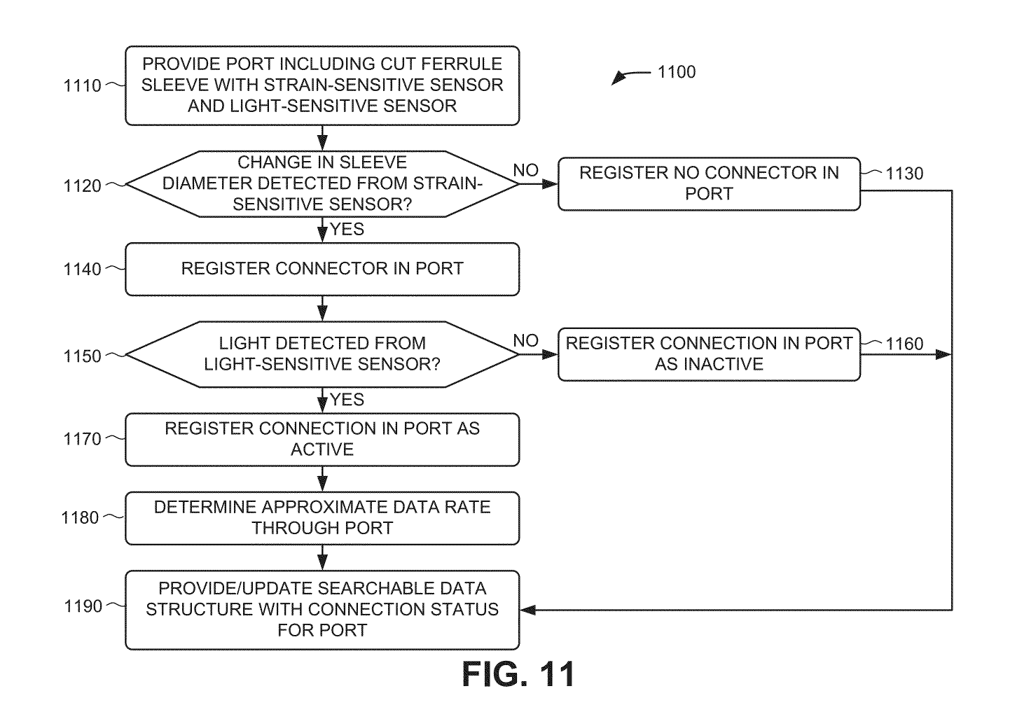

FIG. 11 is a flow chart of a process for registering optical fiber connections according to an implementation described herein. Process 1100 may include providing a port including a cut sleeve with a strain-sensitive sensor and a light-sensitive sensor (block 1110). For example, as described above in connection with FIG. 1, a port 20 may be configured with an adaptor having cut sleeve 110. Cut sleeve 110 may include a strain sensing module 310 and a light sensing module 320.

Process 1100 may further include determining whether a change in sleeve diameter is detected by the strain-sensitive sensor (block 1120). For example, microchip 110 may include a strain sensing module 310 with a sensor that varies its electrical resistance with applied force. Strain sensing module 310 may detect a change in diameter of cylinder 102 of cut sleeve 100 as a ferrule is inserted into or removed from either end of cut sleeve 100. In one implementation, strain sensing module 310 may be calibrated to detect whether ferrules are inserted into none, one, or both ends of cut sleeve 100.

If a change in sleeve diameter is not detected by the strain-sensitive sensor (block 1120—NO), process 1100 may include registering no connector in the port (block 1130). For example, microchip 110 may provide a signal to central computer 920 that indicates a corresponding port is open when strain sensing module 310 detects that one or no ferrules are inserted into cut sleeve 100.

If a change in sleeve diameter is detected by the strain-sensitive sensor (block 1120—YES), process 1100 may include registering a connector in the port (block 1140) and determining whether light is detected from the light-sensitive sensor (block 1150). For example, microchip 110 may provide a signal to central computer 920 that indicates a corresponding port has a connector inserted when strain sensing module 310 detects that ferrules are inserted into both ends of cut sleeve 100. Light sensing module 320 of microchip 110 may then monitor for connector leakage from optical signals passing through optical fibers cores 14. In one implementation, light sensing module 320 may monitor for property changes associated with an infrared-sensitive material of cut sleeve 100.

If light is not detected from the light-sensitive sensor (block 1150—NO), then process 800 may include registering the connector in the port as inactive (block 1160). For example, microchip 110 may provide a signal to central computer 920 that indicates a corresponding port is not carrying traffic when light sensing module 320 detects no infrared leakage within cut sleeve 100.

If light is detected from the light-sensitive sensor (block 1150—YES), then process 1100 may include registering the connector in the port as active (block 1170) and determining an approximate data rate through the port (block 1180). For example, microchip 110 may provide a signal to central computer 920 that indicates that signals are being sent through the port when light sensing module 320 detects infrared leakage within cut sleeve 100. In on implementation, microchip 110 may also identify separations between individual infrared leakage instances (e.g., flickering) inside cut sleeve 100 and may determine an approximate data rate for communications through the port based on the rate of separations/flickering in cut sleeve 100.

Process 1100 may also include providing and/or updating a searchable data structure with the connection status for the port (block 1190). For example, microchip 110 may provide an indication of no connector, an inactive connection, or an active connection to another device, such as central computer 920. In one implementation, the indication of an active connection may also include an approximate data rate (or data from which the approximate data rate may be determined). The connection status may be associated with a particular port 915 (e.g., based on a previous registration of a unique identifier of microchip 110 with the particular port). The connection status may be stored in a searchable database that may be accessed, for example, by other devices within a local data center.

As described above, systems and methods may include a cut sleeve including a cylinder with a discontinuity along an axial length of cylinder. The cylinder may be sized to receive a first fiber ferrule and a second fiber ferrule of substantially equal diameters. The cut sleeve may include a strain sensing module and a light sensing module. The strain sensing module can detect insertion of the first fiber ferrule or the second fiber ferrule into the cylinder. The light sensing module can detect infrared light at an interface of the first fiber ferrule and the second fiber ferrule within the cylinder. In one implementation, the ferrule sleeve may include a signaling module to communicate changes detected by the strain sensing module and light sensing module to another device, such as a central computer.

The systems and methods described herein may utilize existing standard connectors and measure naturally occurring phenomena associated with a fiber optic connector (e.g., stress/strain and radiated infrared light). The systems and methods may obtain physical connection information and detect whether signals are passing through a fiber optic connection without the need for tapping or other intrusive detections methods.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIG. 11, the order of the blocks may be modified in other implementations. Further, non-dependent blocks may be performed in parallel.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A cut sleeve, comprising:
a cylinder including a discontinuity along an axial length of cylinder, wherein the cylinder is sized to receive a first fiber ferrule and a second fiber ferrule of substantially equal diameters;
a strain sensing module, wherein the strain sensing module detects insertion of the first fiber ferrule or the second fiber ferrule into the cylinder; and
a light sensing module, wherein the light sensing module detects infrared light at an interface of the first fiber ferrule and the second fiber ferrule within the cylinder.

2. The cut sleeve of claim 1, wherein a microchip includes the strain sensing module and the light sensing module.

3. The cut sleeve of claim 2, wherein the microchip is powered via a wired connection.

4. The cut sleeve of claim 1, wherein the strain sensing module includes a strain gauge mounted to the cylinder to detect a change in diameter of the cylinder.

5. The cut sleeve of claim 1, wherein the light sensing module includes a sensor to directly detect infrared light within the cylinder.

6. The cut sleeve of claim 1, wherein the cylinder includes an infrared sensitive material to receive infrared light from the interface of the first fiber ferrule and the second fiber ferrule, and
wherein the light sensing module detects a response of the infrared sensitive material, to the infrared light, when signals are sent through the interface.

7. The cut sleeve of claim 1, further comprising a communications module to:
indicate that an adaptor has a connector inserted when the strain sensing module detects insertion of the first fiber ferrule or the second fiber ferrule into the cylinder; and
indicate that signals are being sent through the adaptor when the light sensing module detects infrared light at the interface of the first fiber ferrule and the second fiber ferrule within the cylinder.

8. The cut sleeve of claim 1, wherein the cut sleeve is included within an adapter that is configured to receive a connector including the first fiber ferrule.

9. The cut sleeve of claim 8, wherein the light sensing module detects separations between infrared light at the interface, wherein the rate of the separations indicate an approximate data rate through fibers in the cut sleeve.

10. The cut sleeve of claim 1, wherein an insertion loss for fibers at the interface of the first fiber ferrule and the second fiber ferrule within the cylinder is 0.75 dB or less.

11. An adaptor for a fiber optic connector, comprising:
a cut sleeve to receive a set of fiber ferrules, wherein the cut sleeve includes:
a strain sensing module, wherein the strain sensing module detects insertion of the set of fiber ferrules into the cut sleeve; and
a light sensing module, wherein the light sensing module detects infrared light at an interface of the set of fiber ferrules within the cut sleeve.

12. The adaptor of claim 11, wherein the strain sensing module and the light sensing module are included on a microchip.

13. The adaptor of claim 12, wherein the microchip is powered via a wired connection.

14. The adaptor of claim 11, wherein the strain sensing module includes a strain gauge mounted to the cut sleeve to detect a change in diameter of the cut sleeve.

15. The adaptor of claim 11, wherein the light sensing module includes a sensor to directly detect infrared light within the cut sleeve.

16. The adaptor of claim 11, wherein the cut sleeve includes an infrared sensitive material to receive infrared light from the interface of the first fiber ferrule and the second fiber ferrule, and
wherein the light sensing module detects a response of the infrared sensitive material, to the infrared light, when signals are sent through the interface.

17. The adaptor of claim 11, wherein the cut sleeve further comprises a communications module to:
indicate that the adaptor has a connector inserted when the strain sensing module detects insertion the set of fiber ferrules into the cut sleeve; and
indicate that signals are being sent through the adaptor when the light sensing module detects infrared light at an interface of the set of fiber ferrules within the cut sleeve.

18. A method, comprising:
receiving a fiber ferrule within a cut sleeve of a fiber optic port;
detecting a change in a diameter of the cut sleeve based on the receiving;
sending a signal, to a remote computing device, to indicate the coupling of a fiber optic connector in the fiber optic port, based on detecting the change in the diameter;
detecting infrared light within the cut sleeve while the fiber ferrule is within the cut sleeve; and
sending a signal, to the remote computing device, to indicate that signals are being sent through the fiber optic port, based on detecting infrared light within the cut sleeve.

19. The method of claim 18, wherein detecting the infrared light comprises:
detecting a response to the infrared light in infrared sensitive material in the cut sleeve.

20. The method of claim 18, wherein detecting the change in the diameter of the cut sleeve comprises:
detecting insertion of the fiber ferrule into a first end of the cut sleeve, and
detecting insertion of another fiber ferrule into a second end of the cut sleeve.
